(19) United States
(12) Patent Application Publication
(10) Pub. No.: US 2010/0282796 A1
(43) Pub. Date: Nov. 11, 2010

(54) Flexible Strap

(75) Inventors: Gordon Wrigley, Tyne and Wear (GB); Paul Townsend, Northumberland (GB)

Correspondence Address: BANNER & WITCOFF, LTD., TEN SOUTH WACKER DRIVE, SUITE 3000, CHICAGO, IL, 60606, US

(73) Assignee: Draeger Safety UK Limited, Northumberland (GB)

(21) Appl. No.: 12/774,047

(22) Filed: May 5, 2010

(30) Foreign Application Priority Data
May 6, 2009 (GB) 0907747.0

(51) Int. Cl. A45F 3/02; A45F 3/14; B05D 1/00; B32B 37/00

(52) U.S. Cl. 224/257; 224/625; 427/209; 156/308.2

(57) ABSTRACT

The present invention relates to a strap 10 of flexible material for use with a harness for breathing apparatus, the strap comprising a core substrate 12 provided on first and second surfaces with a flame retardant layer 14, 16.

The present invention relates to an improved strap of flexible material, in particular, an improved strap of flexible material for use with a harness for breathing apparatus.

Self-contained breathing apparatus (SCBA) harnesses comprise a back plate (or frame) to which a cylinder of breathable gas is mounted. The cylinder of gas is retained on the back plate using a flexible cylinder-retaining strap that is attached to the back plate and tensioned around the cylinder. Typically two flexible shoulder straps are each attached at a first end to an upper portion of the back plate and at a second end to a lower portion of the back plate. A flexible waist strap (or belt) is also attached to the back plate. This enables the harness to be carried on the back of a user.

For breathing apparatus of the above kind which is used by fire-fighters, it is important that the cylinder-retaining, waist and shoulder straps are flame retardant because the harness must be capable of withstanding high-temperatures.

It is known to use straps that are woven from Kevlar (®) or Nomex (®) fibres. Such straps are intrinsically flame retardant but are relatively expensive due to the cost of Kevlar and Nomex. The straps that are produced from the aforementioned materials must also be sealed at their edges in order to prevent fraying. However, it is not possible to heat-seal the ends because of the flame retardant properties of the fibres. The ends of the straps must therefore be folded over twice and stitched. This results in additional manufacturing expense and time.

According to one aspect of the present invention there is provided an elongate strap of flexible material for use with a harness for breathing apparatus, the strap comprising a core substrate provided on first and second surfaces with a flame retardant layer. Preferably the flame retardant layer is a coated layer. The core substrate is preferably a textile. The strap can be manufactured cheaply and easily and the flame retardant layers allow the strap to be used in high-temperature environments. In a particularly preferred arrangement the flame retardant layers are non-slip. Use of the non-slip material means that the strap can grip adjacent objects.

In one embodiment the flame retardant layers are rubber. The rubber may be a synthetic rubber, a butyl/nitrile synthetic rubber mix; silicone rubber or flexible PVC. The flame retardant layers may have anti-oxidant additives to improve the flame retardant properties. The thickness of the flame retardant layers may be between 0.3-1 mm.

The textile material may be a polyamide such as nylon. The thickness of the textile may be 0.5-1.5 mm. The textile may be woven, comprising warp threads and weft threads. Preferably the strap is formed such that the warp threads of the textile extend in a direction of elongation of the strap, to provide strength.

The invention also comprises a gas-cylinder retaining strap, or a shoulder strap, or a waist strap for a harness for breathing apparatus comprising a strap according to any statement herein.

The invention also comprises a breathing apparatus having a strap according to any statement herein.

According to a second aspect of the present invention there is provided a method of manufacturing a strap of flexible material for use with a harness for breathing apparatus, the method comprising applying a flame retardant layer to first and second surfaces of a textile. Preferably the flame retardant layer is provided as a coating. The flame retardant layer may be non-slip. The flame retardant layer may be applied to the first and second surfaces of the textile under heat and/or pressure.

In one embodiment the strap is formed from a woven textile having warp threads and weft threads. Preferably the strap is formed such that the warp threads extend in the direction of elongation of the strap.

The invention may comprise any combination of the features and/or limitations referred to herein, except combinations of such features as are mutually exclusive.

Embodiments of the present invention will now be described, by way of example, with reference to the accompanying drawings, in which:

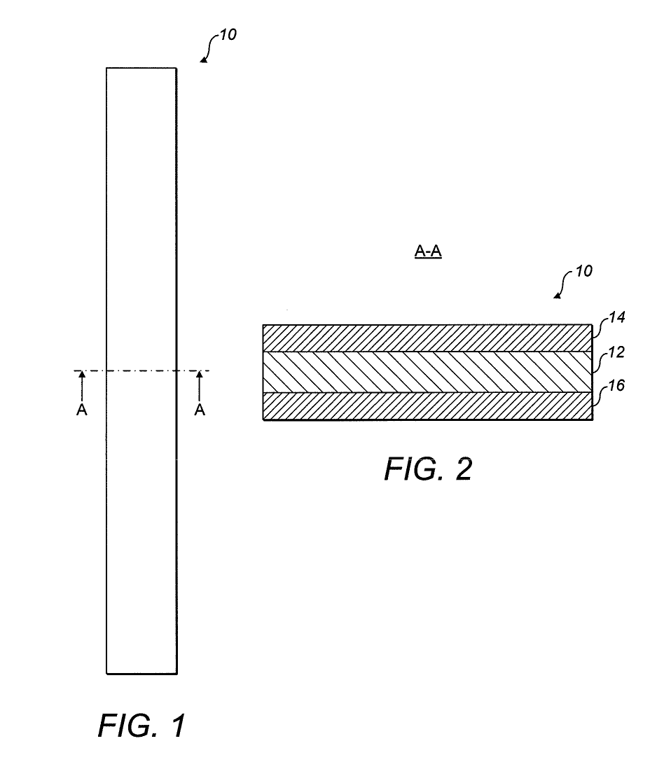

FIG. 1 schematically shows an elongate strap of flexible material according to the present invention;

FIG. 2 schematically shows the cross-section A-A of FIG. 1;

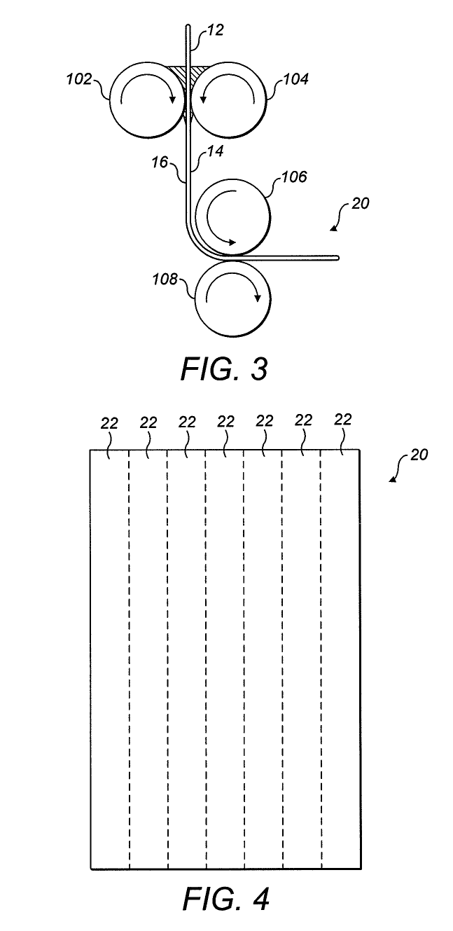

FIG. 3 schematically shows a method of manufacturing a strap according to the present invention;

FIG. 4 schematically shows a sheet of material from which a number of straps can be cut; and

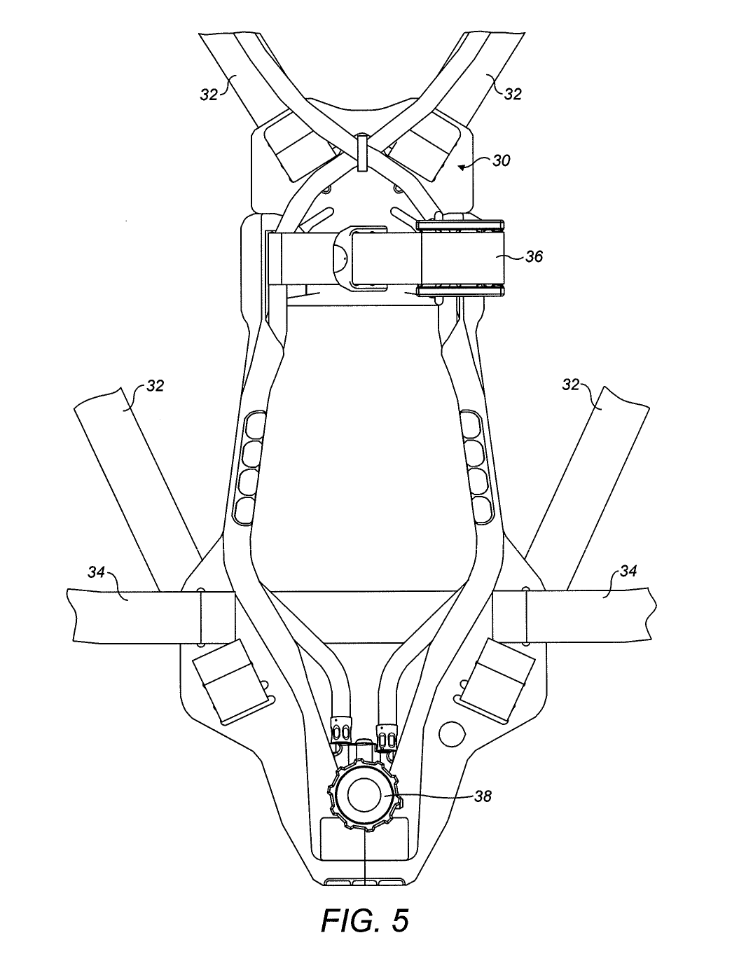

FIG. 5 schematically shows a number of straps used on a harness for breathing apparatus.

FIG. 1 shows a flexible elongate strap 10 according to the present invention. The strap 10 has a layered structure as shown in FIG. 2. The layered structure comprises a woven textile 12 with coated layers 14, 16 on first and second surfaces, of a flame-retardant non-slip material.

In this embodiment the textile is woven from polyamide fibres such as nylon. The woven nylon is 1000 denier and has a thickness of approximately 1.25 mm. The flame retardant non-slip material layers 14, 16 are of a butyl/nitrile synthetic rubber mix which is flame retardant. The addition of anti-oxidant additives improves the flame retardant properties of the non-slip layers 14, 16. Each of the non-slip layers has a thickness of approximately 0.7 mm.

With reference to FIG. 3, a sheet 20 of the flexible layered material used to make the strap 10 is manufactured by calendaring the butyl/nitrile synthetic rubber mix onto both sides of a sheet of woven nylon 12. This is done by heating the synthetic rubber mix and continuously pouring it onto both surfaces of the woven nylon sheet 12 whilst feeding the sheet of woven nylon through two oppositely rotating rollers 102, 104. The pressure of the rollers 102, 104 causes a layer of synthetic rubber mix to become bonded to each side of the woven sheet of nylon. The sheet of woven nylon 12 coated with layers 14, 16 of synthetic rubber on either side is then fed through a second set of oppositely rotating rollers 106, 108 so as to apply further pressure to the layered material. This manufacturing method results in the layered structure of FIG. 2.

The woven nylon textile 12 has a textured surface and the synthetic rubber mix is applied to first and second surfaces under the action of pressure and heat. This results in a laminate structure the layers of which are difficult to separate.

Referring now to FIG. 4, the sheet of flexible material 20 manufactured by the above described process is cut into a series of elongate strips 22. The sheet 20 is cut parallel to the direction of elongation of the warp threads of the woven textile for optimum strength. The strips 22 can then be cut into the required lengths to form straps 10. It is not necessary to seal the ends or edges of the straps 10 because the rubber layers 14, 16 prevent the woven nylon textile 10 from fraying.

The straps 10 can be manufactured quickly, easily and cheaply. The woven nylon textile 12 is a relatively cheap material but is not flame retardant. The flame retardant rubber layers 14, 16 shield the woven nylon core 12 and ensure that the straps as a whole are flame retardant. The strength of the strap 10 is provided by the woven nylon textile material 12. Specifically, the warp threads that extend along the direction of elongation of the strap provide the strength of the strap 10. The strap 10 is also slightly elastic which is particularly useful for certain applications which require a strap to retain an object under tension.

The strap 10 has a non-slip surface on either side that in this embodiment is provided by the synthetic rubber layers 14, 16. This means that the strap 10 has a relatively high coefficient of friction and therefore exhibits gripping properties.

FIG. 5 shows the straps 10 being used on a harness 30 for breathing apparatus that is to be worn on the back of a user. The straps 10 are used as shoulder straps 32, a waist strap 34 and a gas-cylinder retaining strap 36 (cylinder not shown).

The non-slip rubber layers 14, 16 of the shoulder and waist straps 32, 34 enable the straps to grip the clothing of the user. This means that the user wearing the harness feels that the harness is held securely and tightly to his/her body. In particular, a secure feeling of the harness against the user's body can be obtained without over tightening the shoulder and waist straps 32, 34 and thus without unduly restricting the wearer's movement.

The non-slip rubber layers 14, 16 of the gas-cylinder retaining strap 36 allow the strap to grip a gas-cylinder loaded onto the harness 30. This inhibits rotation which would exert an unwanted stress on the connection between the gas-cylinder and the reducer valve 38 to which it is connected. Conventionally, a separate rubber pad is provided in order to inhibit rotation of the gas-cylinder. The use of a cylinder-retaining strap 36 having a non-slip coating therefore removes the need for the separate rubber pad which therefore reduces both the cost of the harness and the assembly time.

As described above, the flame retardant layers 14, 16 of the woven nylon textile 12 renders the straps 10 flame retardant. This means that they can be used on a harness for breathing apparatus used by fire-fighters and the like in high-temperature environments.

1. A strap of flexible material for use with a harness for breathing apparatus, the strap comprising a core substrate provided on first and second surfaces with a flame retardant layer.

2. A strap according to claim 1, wherein the core substrate is a textile.

3. A strap according to claim 1, wherein the flame retardant layer is a coated layer.

4. A strap according to claim 1, wherein the flame retardant layer is non-slip.

5. A strap according to claim 1, wherein the flame retardant layer is rubber.

6. A strap according to claim 5, wherein the rubber is a synthetic rubber, a butyl/nitrile synthetic rubber mix; silicone rubber or flexible PVC rubber.

7. A strap according to claim 1, wherein the flame retardant material comprises anti-oxidant additives.

8. A strap according to claim 1, wherein the thickness of each of the flame retardant layers is between 0.3-1 mm.

9. A strap according to claim 2, wherein the textile material is a polyamide.

10. A strap according to claim 1, wherein the thickness of the core substrate is 0.5-1.5 mm.

11. A strap according to claim 2, wherein the textile is woven comprising warp threads and weft threads.

12. A strap according to claim 11, wherein the strap is formed such that the warp threads of the textile extend in a direction of elongation of the strap.

13. A gas-cylinder retaining strap for a harness for breathing apparatus comprising an elongate strap according to claim 1.

14. A shoulder strap for a harness for breathing apparatus comprising a strap according to claim 1.

15. A waist strap for a harness for breathing apparatus comprising a strap according to claim 1.

16. A harness for breathing apparatus comprising a strap according to claim 13.

17. A method of manufacturing a strap of flexible material for use with a harness for breathing apparatus, comprising applying a flame retardant layer to first and second surfaces of a core substrate.

18. A method of manufacturing a strap according to claim 17, wherein the core substrate comprises a textile.

19. A method of manufacturing a strap according to claim 17, wherein the flame retardant layer is provided as a coating.

20. A method of manufacturing a strap according to claim 17, wherein the flame retardant layer is non-slip.

21. A method of manufacturing a strap according to claims 17, wherein the flame retardant layer is applied to the first and second surfaces of the core substrate under heat and/or pressure.

22. A method of manufacturing a strap according to claim 18, wherein the textile is a woven textile having warp threads and weft threads.

23. A method of manufacturing a strap according to claim 22, wherein the warp threads extend in a direction of elongation of the strap.

24. A strap of flexible material substantially as described herein with reference to the accompanying drawings.
